(19) United States
(12) Patent Application Publication
(10) Pub. No.: US 2026/0227757 A1
(43) Pub. Date: Aug. 6, 2026

(54) Systems and Methods to Track Sources of Data Value Modifications in Industrial Devices Within Industrial Systems

(71) Applicant: ROCKWELL AUTOMATION TECHNOLOGIES, INC., MAYFIELD HEIGHTS, OH (US)

(72) Inventors: Ronald E. Bliss, Twinsburg, OH (US); Justin Wengatz, North Ridgeville, OH (US); Daniel Clark, Chardon, OH (US)

(21) Appl. No.: 19/043,142

(22) Filed: Jan. 31, 2025

(51) Int. Cl. G05B 19/406

(52) U.S. Cl. CPC G05B 19/406; G05B 2219/33284

(57) ABSTRACT

Systems, industrial devices, and methods to track sources of data value modifications in industrial devices within industrial systems. One industrial device includes one or more electronic processors to: detect a data value write operation at the industrial device; generate a data packet corresponding to the data value write operation, the data packet to include source information that indicates a source of the data value write operation; and transmit the data packet to a remote device, the remote device to facilitate diagnostics of the industrial system based on the data packet.

### BACKGROUND

This disclosure relates to industrial environments and platforms such as industrial automation systems or manufacturing environments. Industrial manufacturing environments may include computing and mechanical systems configured to implement an industrial process. In industrial automation environments, control systems are used to drive various operations along an industrial line. Control programs are developed by programmers in integrated design applications. The integrated design applications may include programming tools to design control schemes for the industrial manufacturing environments. The control programs are used by control systems like Programmable Logic Controllers (“PLCs”) to drive the industrial assets, devices, and sensors in an industrial process. The integrated design applications communicate with numerous systems within industrial manufacturing environments like PLCs and orchestration systems. Integrated design applications may also communicate with external systems. The numerous communication links may create security vulnerabilities in the integrated design applications.

The discussion above is merely provided for general background information and is not intended to be used as an aid in determining the scope of the claimed subject matter.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides an industrial device of an industrial system. The industrial device may include one or more electronic processors. The one or more electronic processors may be configured to detect a data value write operation at the industrial device. The one or more electronic processors may be configured to generate a data packet corresponding to the data value write operation, the data packet may include source information that indicates a source of the data value write operation. The one or more electronic processors may be configured to transmit the data packet to a remote device, the remote device may facilitate diagnostics of the industrial system based on the data packet.

In some examples, the technology disclosed herein provides a system for tracking data value changes within an industrial system. The system may include an industrial controller. The industrial controller may be configured to detect execution of a data value write operation at the industrial controller; generate a data packet corresponding to the data value write operation, the data packet to include source information that indicates a source of the data value write operation; and transmit the data packet to a remove device, the remote device to facilitate diagnostics of the industrial system based on the data packet.

In some examples, the technology disclosed herein provides a method for tracking data changes at an industrial controller of an industrial system. The method may include detecting, with the industrial controller, an event, wherein the event is a data value write operation at the industrial controller. The method may include determining, with the industrial controller, information related to execution of the data value write operation at the industrial controller, the information to include source information indicating a source of the data value write operation. The method may include generating, with the industrial controller, a data packet related to execution of the data value write operation at the industrial controller, the data packet to include the information related to execution of the data value write operation. The method may include transmitting, with the industrial controller, the data packet to a remote device, the remote device to facilitate diagnostics of the industrial system based on the data packet.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for tracking a source of a data value modification in an industrial device within an industrial system according to some configurations.

FIG. 2 schematically illustrates an example industrial controller according to some configurations.

FIG. 3 is a flowchart illustrating a method for tracking a source of a data value modification in an industrial device within an industrial system according to some configurations.

FIG. 4 illustrates an example workflow diagram according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

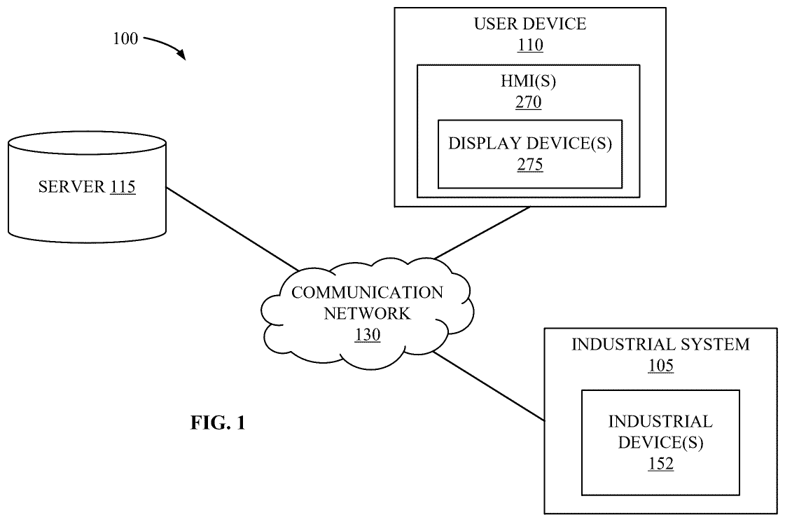

FIG. 1 schematically illustrates an example system 100 for tracking a source of a data value modification in an industrial device within an industrial system according to some configurations. In the illustrated example, the system 100 may include an industrial system 105, and a user device 110. In some configurations, the system 100 includes fewer, additional, or different components in different configurations than illustrated in FIG. 1. As one example, the system 100 may include multiple industrial systems 105, multiple user devices 110, or a combination thereof. As another example, one or more components of the system 100 may be combined into a single device. Alternatively, or in addition, in some configurations, the user device 110 may be included as part of the industrial system 105 (e.g., as a component of the industrial system 105).

The industrial system 105 and the user device 110 may communicate over one or more wired or wireless communication networks 130. Portions of the communication networks 130 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 130. Also, in some configurations, the components of the system 100 may communicate through one or more intermediary devices not illustrated in FIG. 1.

The industrial system 105 may be a manufacturing system, such as, e.g., an industrial automation system or the like. The industrial system 105 may be associated with (or located at) a facility or site. In some configurations, a facility or site may include multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, automation processes, or the like. In some configurations, the industrial system 105 may perform a production method that produces goods or products. As one example, the industrial system 105 may perform a vehicle manufacturing process to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

In the illustrated example, the industrial system 105 may include one or more industrial devices 152 (referred to herein collectively as “the industrial devices 152” and individually as “the industrial device 152”). The industrial device 152 may be a physical piece of equipment included in the industrial system 105. For example, an industrial device 152 may include a pump, a press, a conveyor, a valve, an industrial controller (e.g., a programmable logic controller (“PLC”) or the like), a switch, a motor, a motion device, a sensor, a server, a database, a human-machine interface (“HMI”), another piece of equipment that may be used in connection with an associated industrial process or application of the industrial system 105, or the like.

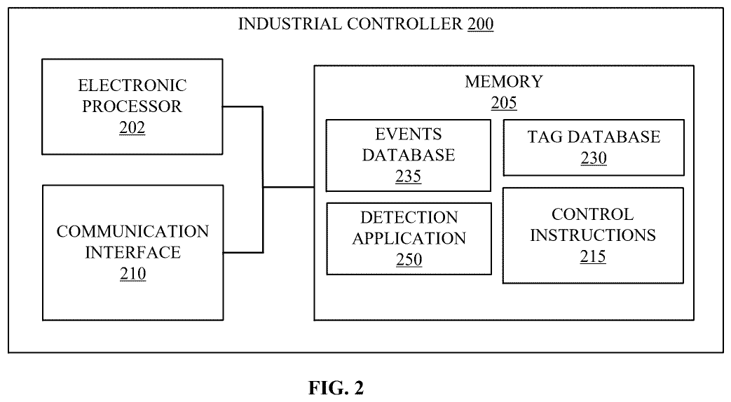

Accordingly, in some configurations, the industrial system 105 may include one or more industrial controllers (e.g., as the industrial device(s) 152). For example, FIG. 2 illustrates an example industrial controller 200 of the industrial system 105. The industrial controller 200 of FIG. 2 may an example of an industrial device 152 of the industrial system 105. Although FIG. 2 illustrates the industrial controller 200, in some configurations the industrial controller 200 may represent other industrial devices 152, such as an industrial drive, an industrial motion device, an industrial switch, an industrial motor, another type of industrial device, or the like

As illustrated in FIG. 2, the industrial controller 200 may include an electronic processor 202, a memory 205, and a communication interface 210. The electronic processor 202, the memory 205, and the communication interface 210 may communicate wirelessly, over one or more communication lines or buses, or a combination thereof. The industrial controller 200 may include additional, different, or fewer components than those illustrated in FIG. 2 in various configurations. The industrial controller 200 may also perform additional or different functionality other than the functionality described herein.

The communication interface 210 may include a transceiver that communicates with the industrial system 105 (e.g., other industrial devices 152 of the industrial system 105), the user device 110, or a combination thereof over the communication network 130 and, optionally, one or more other communication networks or connections. In some configurations, the communication interface 210 enables the industrial controller 200 to communicate with the industrial system 105 (e.g., other industrial devices 152 of the industrial system 105), the user device 110, or a combination thereof over one or more wired or wireless connections. The electronic processor 202 may include a microprocessor, an application-specific integrated circuit (“ASIC”), or another suitable electronic device for processing data, and the memory 205 includes a non-transitory, computer-readable storage medium. The electronic processor 202 is configured to retrieve instructions and data from the memory 205 and execute the instructions.

For example, as illustrated in FIG. 2, the memory 205 may include control instructions 215. The control instructions 215 may be a control program of the industrial controller 200. For instance, the control instructions 215 may include one or more executable instructions that implement (or otherwise) control implementation or execution of an industrial process of the industrial system 105. In some examples, the control instructions 215 may control performance of various functions (or logic) by one or more of the industrial devices 152 (e.g., drive industrial assets, devices, and sensors in an industrial process of the industrial system 105). In some instances, the control instructions 215 may relate to, e.g., a monitoring process, an automation process, a data acquisition process, a sequence management process, an error detection process, a fault detection process, etc. For example, the control instructions 215 may include one or more operations related to the industrial device(s) 152, such as, e.g., one or more switching operations, load isolation operations, signal routing operations, torque control operations, acceleration control operations, deceleration control operations, or the like. In some instances, execution of the control instruction(s) 215 (or a portion thereof) may involve (or otherwise include) one or more logic functions. For example, the electronic processor 202 may perform (or otherwise execute) a logic function to execute the control instruction(s) 215 (or a portion thereof). As one example, the control instruction(s) 215 may include a routine involving a sequence of logic to be executed as a block (e.g., a sequence of one or more logic functions). Following this example, to execute the control instruction(s) 215, the electronic processor 202 may execute the routine by executing the sequence of logic of that routine. As illustrated in FIG. 2, the control instructions 215 are included in the memory 205 of the industrial controller 200. However, in some configurations, the control instructions 215 (or a portion thereof), may be included in a separate device accessible by the industrial controller 200 (included in the industrial controller 200 or external to the industrial controller 200).

As illustrated in FIG. 2, the memory 230 may include a tag database 230. The tag database 230 may include at least one tag. A tag may represent (or otherwise indicate) a memory location where data is stored (e.g., where a data value is stored within, e.g., the memory 230). A tag may be created and used in a control program (e.g., the control instructions 25) to define parameters, organize information, etc. with respect to the control program (or data utilized thereby). For instance, a tag may be associated with a name, a data type, a data value, a scope, a description, a usage type, etc. In some cases, each tag instance may include (or otherwise be associated with) a data type and a data value. A data type may represent a particular type or category of data while a data value may represent a particular value or instance of a specific data type. In some instances, a data value may refer to a data value implemented (or otherwise utilized) by the industrial controller 200, such as, e.g., when performing an industrial control process (e.g., executing the control instructions 215). Accordingly, in some configurations, a tag may represent (or otherwise indicate) a data value, a data type, and a memory location of that data value in memory (e.g., the memory 230).

In some configurations, a tag may be associated with a data value, such as, e.g., a data value to be monitored. For instance, in some configurations, the tag database 230 may include one or more tags (or tag instance(s)) that indicate one or more data values to be monitored. For example, a user may select one or more data tags to be monitored such that a data value of that data tag is monitored. As such, in some examples, the tag database 230 may include a listing (or collection) of tags, where each tag may indicate a data value to be monitored. As one example, the tag database 230 may include a first tag associated with a first data value and a second tag associated with a second, different data value. Following this example, when the first tag and the second tag are designated for monitoring (e.g., via user selection), the technology disclosed herein may monitor or detect data value changes of the first data value and the second data value.

In some instances, the tag database 230 may include one or more tags that are not designated (or otherwise selected) for monitoring. In such instances, the tags that are designated for monitoring may be flagged or otherwise differentiated from the tag(s) that are not designated for monitoring, such that the technology disclosed herein monitors the tags that are designated for monitoring and does not monitor the tags that are not designated for monitoring.

As illustrate in FIG. 2, the memory 20 may also store an events database 235. The events database 235 may store one or more events. In some instances, the events database 235 may store the event(s) as a sequence of events experienced (or performed) by the industrial controller 200. In some configurations, an event may refer to (or otherwise represent) an occurrence that triggers an action (e.g., an event task). In some examples, the event may be an occurrence within the industrial controller 200 that triggers a predefined action. In some instances, an event may function as a signal to execute a piece of code or task when a particular condition is met, such as, e.g., a change in a sensor value, an input signal, a data value change, etc.

In some configurations, the event may be associated with (or otherwise include) a data value write operation. A data value write operation may result in changing (or modifying) a data value of a data type. For instance, when a data value write operation is performed, a present value of a data type (a first data value, such as, e.g., a data value prior to performance of the data value write operation) may be changed to a new data value (a second data value, such as, e.g., a data value resulting from performance of the data value write operation).

Performance of a data value write operation may be triggered responsive to one or more conditions (e.g., occurrence(s) within the industrial controller 200). As one example, the electronic processor 202 may perform a data value write operation based on (or responsive to) receipt of a request to perform the data value write operation (e.g., responsive to an external message or request), as described in greater detail herein. As another example, the electronic processor 202 may perform a data value write operation based on (or response to) execution (or performance) of a logic function, such as, e.g., as part of executing the control instruction(s) 215 (or a portion thereof), as described in greater detail herein.

As one specific example, when the industrial controller 200 receives a request to change a data value (e.g., perform a data value write operation with respect to the data value), receipt of the request may trigger the industrial controller 200 to perform a data value write operation with respect to the data value, which may change a present value of the data value (a first data value, such as, e.g., a data value prior to performance of the data value write operation) to a new data value (a second data value, such as, e.g., a data value resulting from performance of the data value write operation). As described in greater detail herein, in some instances, such a request may be an external request or message, such as, e.g., a manual request of a user originating from the user device 110.

Accordingly, in some configurations, the events database 225 may store information or data related to (or indicative of) the event(s), such as, e.g., an indication of the event, a condition or occurrence triggering the event (e.g., receipt of an external request or message or the like), a type of event (e.g., a data value write operation or the like). In some instance, the events database may also store information related to the event (e.g., one or more data values related to performance of the data value write operation, a first data value (original data value), a second data value (resulting or new data value), etc.), temporal information (e.g., a timestamp of the event, such as a data value write operation), source information, etc. In some instances, the temporal information (e.g., timestamp) may be based on a real-time (or near real-time) clock of the device.

In some configurations, source information may refer to information or data indicative (or otherwise associated with) a source of an event (e.g., a source that caused the event or otherwise triggered the event). Alternatively, or in addition, the source information may include additional information related to the source of the event. For example, a source may be a source of a data change, such as, e.g., a data value write operation. As one example, when a source of an event (e.g., a data value write operation) is logic operations (or execution thereof) (e.g., execution of the control instructions 215 or a portion thereof), the source information may indicate that the source is a logic operation and may include additional information, such as, e.g., a location of the logic in the industrial controller 200 (e.g., program, routine, rung, sheet, line number, block, step(s), transition(s), instruction(s), etc.). As another example, when the source of an event (e.g., a data value write operation) is a user, the source information may indicate that the source is a user and may include additional information, such as, e.g., an identifier or credential of the user, a network address of a workstation at which the event was performed from (e.g., a MAC address, an IP address, etc.), etc. As another example, when the source of an event (e.g., a data value write operation) is an external message, the source information may indicate that the source is an external message (or request) and may include additional information, such as, e.g., an IP address of the origination of the message, a slot number, a port associated with the external message (or request), a device credential (e.g., OPC UA certification information), etc.

In some configurations, the electronic processor 202 may generate a data packet for each event. For example, with respect to a particular event, the electronic processor 202 may compile (or otherwise aggregate) information or data related to (or indicative of) that particular event as a data packet that includes the compiled (or aggregated) information or data of the particular event. In some instances, the electronic processor 202 may store the data packet to the event database 235 (e.g., as an “event”). Accordingly, in some instances, the event database 235 may store the event(s) as data packets, wherein each data packet may represent a respective event. In some configurations, the event database 235 may store an event log or record for the event(s) of the industrial controller 200. In such configurations, the log or record may include one or more data packets representing the event(s) of the industrial controller 200.

Accordingly, in some configurations, the events database 235 may store events, such as, e.g., a data value write operation, a status, a change in setpoints, a modification of device settings, or the like. For instance, when a device parameter is modified by a user (e.g., either locally or through a remote interface) or automatically by a control system, the electronic processor 202 may update the event database 235 to include that event (e.g., an indication of that event, an event type, and additional information related to that event, as described herein).

As illustrated in FIG. 2, the events database 235 and the tag database 230 are included in the memory 205 of industrial controller 200. However, in some configurations, the events database 235 or the tag database 230 (or a portion thereof) is included in a separate device accessible by the industrial controller 200.

In some configurations, the memory 205 may include a detection application 250 (referred to herein as “the application 250”). The application 250 may be a software application executable by the electronic processor 202 in the example illustrated and as specifically discussed below, although a similarly purposed module may be implemented in other ways in other examples. The electronic processor 202 may execute the application 250 to provide services to track sources of data value modifications (e.g., monitor or track events at the industrial controller 200), as described in greater detail herein. For example, the application 250 may provide a messaging service to alert a user of an event occurrence (e.g., using the user device 110), a logging service to create a record of event occurrences (e.g., using the events database 235), or other functionality described herein.

The application 250 may include steps that may be performed by electronic processor 202 to detect events and generate a report. In some instances, the application 250 may include steps that instruct the electronic processor 200 to detect a data value write operation at the industrial device, generate a data packet corresponding to the data value write operation, and transmit the data pack to a remote device.

As illustrated in FIG. 2, the application 250 is included in the memory 205 of the industrial controller 200. However, in some configurations, the application 250 may be included in a separate device accessible by the industrial controller 200 (included in the industrial controller 200 or external to the industrial controller 200). For example, the application 250 (or a portion thereof) may be stored at the user device 110, the industrial device(s) 152, or the like. As described in greater detail herein, in some examples, the application 250 may be stored locally at one or more of the industrial devices 152. For example, in some configurations, each of the industrial devices 152 may store and execute the application 250 (e.g., a local copy of the application 250 executable locally by each of the industrial devices 152).

Returning to FIG. 1, the system 100 may include the user device 110. The user device 110 may also include a computing device, such as a desktop computer, a laptop computer, a tablet computer, a terminal, a smart telephone, a smart television, a smart wearable, or another suitable computing device that interfaces with a user. In some examples, the user device 110 may be included as a component of the industrial system 105, such as, e.g., an HMI of the industrial system 105. However, in some configurations, such as the configuration illustrated in FIG. 1, the user device 110 may be separate or remote from the industrial system 105.

The user device 110 may be used by a user in relation to data change tracking, as described herein. For instance, a user may use the user device 110 to interact with information associated with the industrial system 105, such as, e.g., data value modification information for the industrial device(s) of the industrial system 105, such as, e.g., data or information stored in the events database 235, as described in greater detail herein. In some configurations, a user may use the user device 110 to facilitate or implement event detection, source information tracking or monitoring corresponding to an event, or a combination thereof for the industrial system 105.

Although not illustrated in FIG. 1, the user device 110 may include similar components as the industrial controller 200, such as electronic processor (e.g., a microprocessor, an ASIC, or another suitable electronic device), a memory (e.g., a non-transitory, computer-readable storage medium), a communication interface, such as a transceiver, for communicating over the communication network 130 and, optionally, one or more additional communication networks or connections, and one or more human machine interfaces. For example, to communicate with the industrial system 105 (or one or more industrial devices 152 thereof), the user device 110 may store a browser application or a dedicated software application executable by an electronic processor. In some configurations, the user device 110 includes additional, fewer, or different components than the industrial controller 200. As noted herein, the functionality (or a portion thereof) described herein as being performed by the user device 110 may be performed by another device of the system 100, distributed among multiple devices of the system 100, combined with another component of the system 100, or a combination thereof. For example, in some configurations, the functionality (or a portion thereof) described as being performed by the user device 110 may be performed by the industrial device(s) 152, another component of the system 100 or industrial system 105, or a combination thereof.

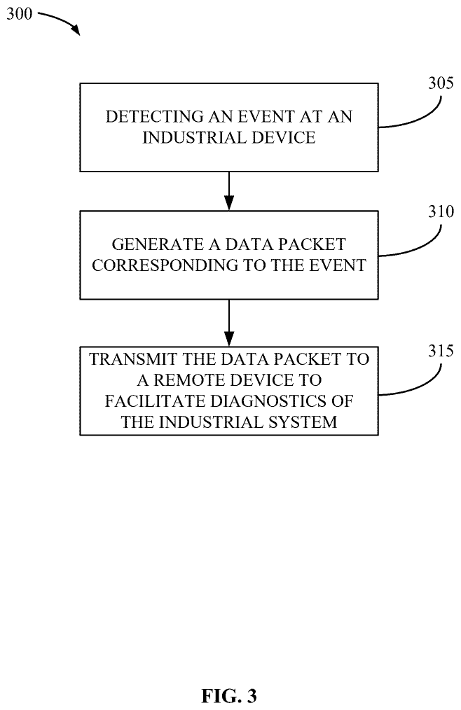

FIG. 3 is a flowchart illustrating a method 300 of tracking sources of data value modifications (e.g., data value write operations) in the industrial device(s) 152 (e.g., the industrial controller 200 of FIG. 2) according to some configurations. The method 300 is described as being performed by industrial controller 200 (e.g., the electronic processor 202 executing the detection application 250). However, as noted herein, the functionality described with respect to the method 300 may be performed by other devices, such as the industrial device(s) 152, the user device 110, another industrial device, another component included in the industrial system 105, or a combination thereof, distributed among a plurality of devices, such as a plurality of servers included in a cloud service, or a combination thereof. As described below, a particular implementation can omit some or all illustrated features/steps, may be implemented in some embodiments in a different order, and may not involve some illustrated features to implement all embodiments.

At step 305, the electronic processor 202 may detect an event. As described herein, in some configurations, the event may include a data value write operation at the industrial controller 200. For instance, in some embodiments, the event can include a data write operation corresponding to changes made to parameters, settings, values, etc. of the industrial controller 200. In some examples, the event may be made internal to the industrial controller 200. For example, a user may directly interact with a user interface on the industrial controller 200 to change a data value at the industrial controller 200 (e.g., to perform the data value write operation). In another example, a user may wirelessly or remotely connect to the industrial controller 200 to perform a data value write operation. Data value write operations, status changes, setpoint modifications, device settings modifications, or the like may trigger protocol associated with the event detection of step 305.

At step 310, the electronic processor 202 may generate a data packet corresponding to the event. In some instances, the electronic processor 202 may be generate the data packet as described in greater detail herein. For instance, in some configurations, the data packet may include timestamp and source information extracted from the event. As noted herein, the source information can indicate a source of the data value write operation, such as, e.g., a location of the industrial controller 200, an identification of a user that initiated the event, an network address of the event origination (e.g., an IP address), a type of device that initiated the event, or the like. In some examples, the source information can include a location of a value change within the logic executed by the industrial controller 200. For example, the source information can indicate one or more programs, routines, rungs, sheets, line numbers, blocks, steps, instructions, or the like that have been modified during the event.

At step 315, the electronic processor 202 may transmit (or otherwise provide) the data packet to a remote device to facilitate diagnostics of the industrial system 105 (or component(s) thereof). In some examples, the electronic processor 202 may transmit the data packet to the user device 110 such that a user of the user device 110 may interact with (e.g., view, manipulate, etc.) content of the data packet (e.g., using a display device of the user device 110).

In some configurations, the electronic processor 202 may generate the data packet as a log record. For instance, in some configurations, the electronic processor 202 may output a log record based on, e.g., timestamps, source information, etc. In some examples, the log record may be presented to an end user or a monitoring system. An end user or monitoring system may facilitate diagnostics of the industrial system based on the data log (or log record). In some examples, the electronic processor 202 may generate diagnostic recommendations based on the information in the data log. In some embodiments, the data log may indicate an initial cause or event associated with a sequence of a plurality of events, as well as a summary of the timestamp and source information associated with the initial cause and/or each of the events in the sequence.

In some embodiments, the log record can be presented in the form of a table, a graph, a flowchart, a schematic, a diagram, or the like. In some examples, the log record may be interactive, allowing the end user to select portions of the log record to expand or view additional information (e.g., via the user device 110). For example, a log record may include hotlinks or hyperlinks that direct the end user to a line within a program in which an event occurred (e.g., a source of the event). In some examples, the log record may display the original program information, as well as any information in the program that was modified during the event.

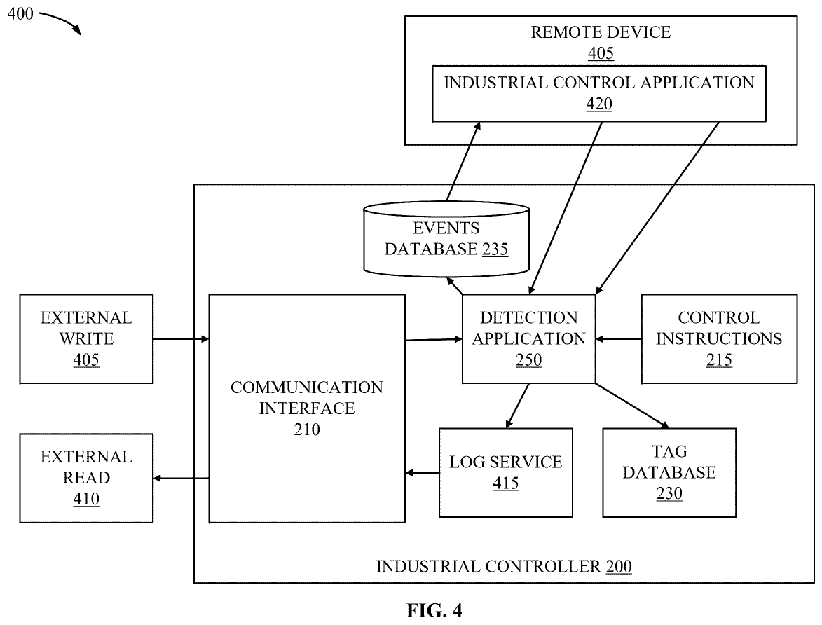

FIG. 4 schematically illustrates an example workflow 400 according to some configurations. As illustrated in FIG. 4, the workflow may include a remote device 405 and the industrial controller 200. In some examples, method 300, as described above, may be performed using the workflow 400 illustrated in FIG. 4.

The remote device 405 may be the user device 110 or another type of computing device, server, database, etc. As illustrated in FIG. 4, the industrial controller 200 can include the events database 235, the communication interface 210, the detection application 250, the control instructions 215, and the tag database 230, as describe herein with respect to FIG. 2. In some embodiments, the communication interface 210 may facilitate external write operations 405 and external read operations 410 between the industrial controller 200 and other components within the system 100, such as, e.g., the user device 110, a user interface associated with the industrial controller 200, another component of the industrial system 105, or the like. The external write operations 405 and the external read operations 410 may be associated with operations such as, e.g., a status update, a change in setpoints, a modification of device settings, or the like (e.g., a data value write operation). In some examples, the external write operation 405 may be an external message or request to perform a data value write operation (e.g., a manual request initiated by a user). Alternatively, or in addition, in some examples, the external write operation 405 may be a message or request to perform a data value write operation (e.g., triggered by another component of the industrial system 105, etc.).

In some examples, as illustrated in FIG. 4, the industrial controller 200 may include a log service 415 (e.g., a software application executable by the electronic processor 202). The log service 415 (when executed by the electronic processor 202) may create a log record corresponding to events detected by the detection application 250, as described herein. For example, the log service 215 may generate a log record including timestamp and source information, as described herein. In some examples, the log service 215 may generate a table, a graph, a flowchart, a schematic, a diagram, or the like containing information stored in both the events database 235 and the tag database 230.

As further illustrated in FIG. 4, the external device 405 (e.g., the user device 110 or an external server or computing device) may run an industrial control application 420. In some examples, the industrial control application 420 may be used to communication with the industrial system 105 (or component(s) thereof). For example, the industrial control application 420 may include an interface for viewing value or information logs corresponding to one or more of the industrial device(s) 152, such as, e.g., status values, operation parameters, sensor outputs, etc. In some examples, the events database 235 of the industrial controller 220 may communication with the information log to provide updates regarding the external write 405 and the externals reads 410 received by the respective industrial controller 200 or industrial device(s) 152. Moreover, in some examples, the industrial control application 420 may include configuration settings and tag monitors. For example, a user may interact with the industrial control application 420 to change desired tag values (as described in greater detail herein), which may be saved to the detection application 250 of the corresponding industrial controller 200 or industrial device(s) 152.

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. An industrial device of an industrial system, the industrial device comprising:
one or more electronic processors to:
detect a data value write operation at the industrial device;
generate a data packet corresponding to the data value write operation, the data packet to include source information that indicates a source of the data value write operation; and
transmit the data packet to a remote device, the remote device to facilitate diagnostics of the industrial system based on the data packet.

2. The device of claim 1, wherein the data value operation includes at least one of an external write operation to the industrial device or an internal write operation to the industrial device.

3. The device of claim 1, wherein the industrial device is at least one of: an industrial controller, an industrial drive device, an industrial motion device, or an industrial switch.

4. The device of claim 1, wherein the source information indicates a storage location of a logic function within the industrial device, wherein the logic function is the source that causes the data value write operation.

5. The device of claim 4, wherein the location includes at least one of: a program, a routine, a rung, a sheet, a line number, a block, a step, a transition, or an instruction.

6. The device of claim 1, wherein the source information indicates a user request to execute the data value write operation, wherein the user request is the source that causes the data value write operation.

7. The device of claim 1, wherein the source information indicates a network address of a device, wherein the device is the source that causes the data value write operation.

8. The device of claim 1, wherein the source information indicates a credential of a device, wherein the device is the source that causes the data value write operation.

9. The device of claim 1, wherein the source information includes a network address relate to an external message, wherein the external message is the source that causes the data value write operation.

10. The device of claim 1, wherein the one or more electronic processors are configured to execute the data value write operation, wherein the data value write operation includes a modification to a data value stored at the industrial device.

11. The device of claim 1, wherein the one or more electronic processors are configured to execute a logic function internal to the industrial device, wherein execution of the logic function causes the data value write operation.

12. The device of claim 1, wherein the one or more electronic processors are configured to receive a user request to execute the data value write operation and, responsive to receipt of the user request, execute the data value write operation.

13. A system for tracking data value changes within an industrial system, the system comprising:
an industrial controller to:
detect execution of a data value write operation at the industrial controller;
generate a data packet corresponding to the data value write operation, the data packet to include source information that indicates a source of the data value write operation; and
transmit the data packet to a remove device, the remote device to facilitate diagnostics of the industrial system based on the data packet.

14. The system of claim 13, wherein the industrial controller is to:
receive an external message that requests execution of the data value write operation; and
responsive to receipt of the external message, execute the data value write operation based on the external message.

15. The system of claim 13, wherein the industrial controller is to:
execute a logic function store at the industrial controller, wherein execution of the logic function results in the data value write operation at the industrial controller.

16. The system of claim 13, wherein the source information includes at least one of:
a network address associated with execution of the data value write operation;
a credential of a device associated with execution of the data value write operation; or
a credential of a user associated with execution of the data value write operation.

17. The system of claim 13, wherein the data packet includes a timestamp associated with the execution of the data value write operation.

18. The system of claim 13, wherein the source information includes a location related to a logic function executed at the industrial controller, wherein execution of the logic function results in the data value write operation.

19. A method for tracking data changes at an industrial controller of an industrial system, the method comprising:
detecting, with the industrial controller, an event, wherein the event is a data value write operation at the industrial controller;
determining, with the industrial controller, information related to execution of the data value write operation at the industrial controller, the information to include source information indicating a source of the data value write operation;
generating, with the industrial controller, a data packet related to execution of the data value write operation at the industrial controller, the data packet to include the information related to execution of the data value write operation; and
transmitting, with the industrial controller, the data packet to a remove device, the remote device to facilitate diagnostics of the industrial system based on the data packet.

20. The method of claim 19, wherein determining, with the industrial controller, the information related to execution of the data value write operation at the industrial controller includes:
determining, with the industrial controller, temporal information related to execution of the data value write operation, the temporal information to include a timestamp corresponding to execution of the data value write operation; and
determining, with the industrial controller, a first data value and a second data value, wherein the second data value is a value resulting from the execution of the data value write operation and the first data value is a previous value prior to the execution of the data value write operation,
wherein the data packet includes the temporal information, the first data value, the second data value, and the source information.
